(19) United States
(12) Patent Application Publication
(10) Pub. No.: US 2003/0156547 A1
(43) Pub. Date: Aug. 21, 2003

(54) System and method for handling overload of requests in a client-server environment

(75) Inventor: Nir Peleg, Beer Yaccov (IL)

Correspondence Address: SUGHRUE MION, PLLC, 2100 PENNSYLVANIA AVENUE, N.W., WASHINGTON, DC, 20037, US

(73) Assignee: EXANET. INC.

(21) Appl. No.: 10/075,762

(22) Filed: Feb. 15, 2002

(51) Int. Cl. H04L 12/28

(52) U.S. Cl. 370/252; 370/411; 370/229

(57) ABSTRACT

A system, method and computer software for handling overload conditions in a request queue of a server in a client-server architecture. When request queue overload conditions are detected, one or more of the next-to-be serviced requests in the request queue of the server are removed and the remaining requests in the queue are forwarded by the same number of requests that were removed. By preventing the servicing of requests that may have already experienced a timeout by the requesting client, the overall performance of the system is increased.

### BACKGROUND OF THE PRESENT INVENTION

1. Technical Field of the Present Invention

This invention relates generally to the handling of requests provided by a client to a server that handles such requests. More specifically, the invention relates to the management of the client requests in cases where the request queue is overloaded, but there is a need to continue to provide a required quality of service.

2. Description of the Related Art

There will now be provided a discussion of various topics to establish a proper foundation for understanding the present invention.

In conventional client-server architectures, one or more nodes are connected to one or more servers via a network that allows for bi-directional communication between a client and a server. Typically, a server receives requests from multiple sources and handles them according to a defined processing scheme. Most commonly, a first-in first-out (FIFO) approach is used allowing for the first received request to be handled first by the server, the second request to be handled second, and so forth.

The quality of service in a given client-server architecture is established based on the latency between a request being sent to a server and the time the requesting client receives a response from the server. The higher the load on a server, the more likely it is that the latency for receiving a response is increased. In many cases, the clients have built-in mechanisms that use “timeout” facilities to avoid waiting long periods of time for a request to be answered. In such cases, the request is aborted, and even if results are directed to the requesting client from the server, the requesting client ignores the results. In some applications, the client generates another request with the expectation that this request will be answered within the allotted time frame. This scheme may result in additional loading of the server's queue, thereby causing additional delays in the server's response time.

Therefore, it would be advantageous to have a mechanism for handling overload situations in a client-server environment. More specifically, it would be advantageous to have a mechanism that actively responds to overload situations and allows the system to perform at its best possible efficiency.

### SUMMARY OF THE PRESENT INVENTION

The present invention has been made in view of the above circumstances and to overcome the above problems and limitations of the prior art.

Additional aspects and advantages of the present invention will be set forth in part in the description that follows and in part will be obvious from the description, or may be learned by practice of the present invention. The aspects and advantages of the present invention may be realized and attained by means of the instrumentalities and combinations particularly pointed out in the appended claims.

A first aspect of the present invention provides a server capable of receiving requests from at least one client. The server comprises a queue for handling requests received from the client. The server further comprises a queue manager that removes client requests from the queue when the number of client requests in the queue exceeds a request threshold value. The server is connected to the client through a network, and the network can be a local area network (LAN), a wide area network (WAN), an Infiniband network or asynchronous transfer mode (ATM) network. The server queue can be a first-in first-out queue. In the present invention, the request threshold value is the result of an average response time of the server to a client request divided by an average time used by the server to process the client request. Alternatively, the request threshold value is the result of a first predetermined number that is larger than an average response time of the server to a client request divided by an average time used by the server to process the client request. In the server, prior to processing of the first client request in the queue, the queue manager determines if there are client requests in the queue and, if that determination is not true, waits until a request is present. Once at least one client request is in the queue, the queue manager determines if the number of client requests in the queue exceeds the request threshold value. If that determination is true, the queue manager repeatedly removes the client request in the first slot of the queue and advances the remaining client requests in the queue by one position until the number of client requests is less than or equal to the request threshold value. After the number of client requests is less than or equal to the request threshold value, the queue manager processes the request that is now stored in the first slot of the queue.

In a second aspect provided by the present invention, prior to processing of the first client request in the queue, the queue manager determines if there are client requests in the queue and, if that determination is not true, waits until a client request is present. Once at least one client request is in the queue, the queue manager determines if the number of client requests in the queue exceeds the request threshold value. If that determination is true, the queue manager removes from the queue a number of client requests equal to the difference between the actual number of client requests in the queue and the request threshold value. The queue manager then advances the remaining client requests the queue by a number of positions equal to the difference between the actual number of client requests in the queue and the request threshold value. After the remaining client requests have been advanced in the queue, the queue manager processes the client request that is now stored in the first slot of the queue.

In a third aspect provided by the present invention, prior to processing of the first client request in the queue, the queue manager determines if there are client requests in the queue and, if that determination is not true, waits until a client request is present. Once a client request is present in the queue, the queue manager determines if the number of client requests in the queue exceeds the first predetermined number. If that determination is true, the queue manager repeatedly removes the client request in the first slot in the queue and advances the remaining client requests in the queue by one position until the number of client requests in the queue is less than a second predetermined number. The second predetermined number is smaller than the first predetermined number. After the queue has been advanced, the queue manager processes the client request that is now stored in the first slot of the queue.

In a fourth aspect provided by the present invention, prior to processing the queue, the queue manager determines if there are client requests in the queue and, if that determination is not true, waits until a client request is present. Once at least one client request is present in the queue, the queue manager determines if the number of client requests in the queue exceeds the first predetermined number. If that determination is true, the queue manager removes from the queue a number of client requests equal to the difference between the actual number of client requests in the queue and a second predetermined number which is smaller than the first predetermined number. The queue manager advances the remaining client requests the queue by a number of positions equal to the difference between the actual number of client requests in the queue and the second predetermined number. After the remaining number of client requests has been advanced in the queue, the queue manager processes the client request that is now stored in the first slot of the queue.

A fifth aspect of the present invention provides a method for handling overload of requests in a client-server environment, with the server having a request queue and a request manager. In the method, the request manager determines if there are client requests in the queue and, if that determination is not true, waits until a client request is present. If the request manager determines that the number of client requests in the queue exceeds the request threshold value, the request manager repeatedly removes the client request in the first slot of the queue. The queue manager advances the remaining client requests in the queue by one position until the number of client requests remaining in the queue is less than or equal to the request threshold value. Afterwards, the request manager processes the client request that is now stored in the first slot of the queue. The request threshold value is the result of an average response time of the server to a client request divided by an average time used by the server to process the client request.

A sixth aspect of the present invention provides a method for handling overload of requests in a client-server environment, with the server having a request queue and a request manager. The request manager determines if there are client requests in the queue and, if that determination is not true, waits until a client request is present. If the request manager determines that the number of client requests in the queue exceeds the request threshold value, the request manager removes from the queue a number of client requests equal to the difference between the actual number of requests in the queue and the request threshold value. After removing the client requests from the queue, the request manager advances the remaining client requests in the queue by a number of positions equal to the difference between the actual number of client requests in the queue and the request threshold value. Afterwards, the request manager processes the client request that is now stored in the first slot of the queue. The request threshold value is the result of an average response time of the server to a client request divided by an average time used by the server to process the client request.

A seventh aspect of the invention provides a method for handling overload of client requests in a client-server environment, with the server having a request queue and a request manager. The request manager determines if there are client requests in the queue and, if that determination is not true, waits until a client request is present. If the request manager determines that the number of client requests in the queue exceeds the first predetermined number, the request manager repeatedly removes the client request in the first slot of the queue. Next, the request manager advances the remaining client requests in the queue by one position until the number of client requests in the queue is less than a second predetermined number, which is smaller than the first predetermined number. Afterwards, the request manager processes the client request that is now stored in the first slot of the queue. The second predetermined number is the result of an average response time of the server to a client request divided by an average time used by the server to process the client request.

An eighth aspect of the present invention provides a method for handling overload of client requests in a client-server environment, with the server having a request queue and a request manager. The request manager determines if there are client requests in the queue and, if that determination is not true, waits until a client request is present. The request manager determines if the number of client requests in the queue exceeds the first predetermined number. If that determination is true, the request manager removes from the queue a number of client requests equal to the difference between the actual number of client requests in the queue and a second predetermined number which is smaller than the first predetermined number. Next, the request manager the remaining client requests the queue by a number of positions equal to the difference between the actual number of client requests in the queue and a second predetermined number. Subsequently, the request manager processes the client request that is now stored in the first slot of the queue.

A ninth aspect of the invention provides a computer software product for handling overload of client requests in a client-server environment, with the server having a request queue and a request manager. The computer software product comprises software instructions that enable the server, the request queue and the request manager to perform predetermined operations, and a computer readable medium bearing the software instructions. The predetermined operations comprise determining if there are client requests in the queue and, if that determination is not true, waiting until a client request is present. If the predetermined operations determine that the number of client requests in the queue exceeds the request threshold value, the predetermined operations repeatedly remove the client request in the first slot of the queue and advance the remaining client requests in the queue by one position until the number of client requests is less than or equal to the request threshold value. After advancing the client requests in the queue, the predetermined operations process the client request that is now stored in the first slot of the queue.

A tenth aspect of the present invention provides a computer software product for handling overload of client requests in a client-server environment, the server having a request queue and a request manager. The computer software product comprises software instructions that enable the server, the request queue and the request manager to perform predetermined operations, and a computer readable medium bearing the software instructions. The predetermined operations comprise determining if there are client requests in the queue and, based upon that determination, waiting until a client request is present. If the predetermined operations determine that the number of client requests in the queue exceeds the request threshold value, the predetermined operations remove from the queue a number of client requests equal to the difference between the actual number of client requests in the queue and the request threshold value. The predetermined operations advance the remaining client requests the queue by a number of positions equal to the difference between the actual number of client requests in the queue and the request threshold value. After the remaining client requests in the queue have been advanced, the predetermined operations process the request that is now stored in the first slot of the queue.

An eleventh aspect of the present invention provides a computer software product for handling overload of client requests in a client-server environment, the server having a request queue and a request manager. The computer software product comprises software instructions that enable the server, the request queue and the request manager to perform predetermined operations, and a computer readable medium bearing the software instructions. The predetermined operations comprise determining if there are client requests in the queue and, based upon that determination, waiting until a client request is present. If the predetermined operations determine that the number of client requests in the queue exceeds a first predetermined number, the predetermined operations repeatedly remove the client request in the first slot of the queue and advance the remaining client requests in the queue by one position until the number of client requests in the queue is less than a second predetermined number. The second predetermined number is smaller than the first predetermined number of requests. After the remaining client requests in the queue have been advanced, the predetermined operations process the client request that is now stored in the first slot of the queue.

A twelfth aspect of the present invention provides a computer software product for handling overload of client requests in a client-server environment, with the server having a request queue and a request manager. The computer software product comprises software instructions that enable the server, the request queue and the request manager to perform predetermined operations, and a computer readable medium bearing the software instructions. The predetermined operations comprise determining if there are client requests in the queue and, if that determination is not true, waits until a client request is present. The predetermined operations determine if the number of client requests in the queue exceeds the first predetermined number. If that determination is true, the predetermined operations remove from the queue a number of client requests equal to the difference between the actual number of client requests in the queue and a second predetermined number. The second predetermined number is smaller than the first predetermined number. The predetermined operations advance the remaining client requests the queue by a number of positions equal to the difference between the actual number of client requests in the queue and the second predetermined number. After the remaining client requests in the queue have been advanced, the predetermined operations process the client request that is now stored in the first slot of the queue.

A thirteenth aspect of the present invention provides a computer system adapted for handling overload of client requests in a client-server environment. The computer system comprises at least one client and at least one server, wherein the client and the server are coupled to each other. The computer system further comprises a memory having software instructions adapted to enable the computer system to perform various operations. The software instructions are adapted to determine if there are client requests in the queue and, if that determination is not true, wait until a client request is present. The software instructions determine if the number of client requests in the queue exceeds the request threshold value. If that determination is true, the software instructions repeatedly remove the client request in the first slot of the queue and advance the remaining client requests in the queue by one position until the number of client requests is less than or equal to the request threshold value. Finally, the software instructions process the client request that is now stored in the first slot of the queue.

A fourteenth aspect of the present invention provides a computer system adapted for handling overload of client requests in a client-server environment. The computer system comprises at least one client and at least one server, wherein the client and the server are coupled to each other. The computer system further comprises a memory having software instructions adapted to enable the computer system to execute various operations. The software instructions are adapted to determine if there are client requests in the queue and, based upon that determination, wait until a client request is present. The software instructions determine if the number of client requests in the queue exceeds the request threshold value. If that determination is true, the software instructions remove from the queue a number of client requests equal to the difference between the actual number of client requests in the queue and the request threshold value. After removal of the client requests, the software instructions advance the remaining client requests the queue by a number of positions equal to the difference between the actual number of client requests in the queue and the request threshold value. After the remaining client requests have been advanced in the queue, the software instructions process the client request that is now stored in the first slot of the queue.

A fifteenth aspect of the present invention provides a computer system adapted for handling overload of client requests in a client-server environment. The computer system comprises at least one client and at least one server, wherein the client and the server are coupled to each other. The computer system further comprises a memory comprising software instructions adapted to enable the computer system to execute operations. The software instructions determine if there are client requests in the queue and, based upon that determination, wait until a client request is present. The software instructions determine if the number of client requests in the queue exceeds the first predetermined number. Based on that determination, the software instructions repeatedly remove the client request in the first slot of the queue and advance the remaining client requests in the queue by one position until the number of requests in the queue is less than a second predetermined number. The second predetermined number is smaller than the first predetermined number. After the remaining client requests have been advanced in the queue, the software instructions process the client request that is stored in the first slot of the queue.

A sixteenth aspect of the present invention provides a computer system adapted for handling overload of client requests in a client-server environment. The computer system comprises at least one client and at least one server, wherein the client and the server are coupled to each other. The computer system further comprises a memory comprising software instructions adapted to enable the computer system to operate. The software instructions determine if there are client requests in the queue and, if that determination is not true, wait until a client request is present. The software instructions determine if the number of client requests in the queue exceeds the first predetermined number. If that determination is true, the software instructions remove from the queue a number of client requests equal to the difference between the actual number of client requests in the queue and a second predetermined number. The second predetermined number is smaller than the first predetermined number. The software instructions advance the remaining client requests the queue by a number of positions equal to the difference between the actual number of client requests in the queue and the second predetermined number. Finally, after the remaining client requests have been advanced in the queue, the software instructions process the client request that is now stored in the first slot of the queue.

The above aspects and advantages of the present invention will become apparent from the following detailed description and with reference to the accompanying drawing figures.

### BRIEF DESCRIPTION OF THE DRAWINGS

The accompanying drawings, which are incorporated in and constitute a part of this specification, illustrate the present invention and, together with the written description, serve to explain the aspects, advantages and principles of the present invention. In the drawings,

FIG. 1 is an exemplary diagram of conventional client-server architecture;

FIG. 2 is an exemplary embodiment of a server request queue according to the present invention;

FIG. 3 is a first exemplary flowchart of server request queue control according to the present invention;

FIGS. 4A-4B is a second exemplary flowchart of server request queue control according to the present invention;

FIG. 5 is a third exemplary flowchart of server request queue control according to the present invention; and

FIG. 6 is a fourth exemplary flowchart of server request queue control according to the present invention.

### DETAILED DESCRIPTION OF THE INVENTION

Prior to describing the aspects of the present invention, some details concerning the prior art will be provided to facilitate the reader's understanding of the present invention and to set forth the meaning of various terms.

As used herein, the term “computer system” encompasses the widest possible meaning and includes, but is not limited to, standalone processors, networked processors, mainframe processors, and processors in a client/server relationship. The term “computer system” is to be understood to include at least a memory and a processor. In general, the memory will store, at one time or another, at least portions of executable program code, and the processor will execute one or more of the instructions included in that executable program code.

As used herein, the terms “predetermined operations,” the term “computer system software” and the term “executable code” mean substantially the same thing for the purposes of this description. It is not necessary to the practice of this invention that the memory and the processor be physically located in the same place. That is to say, it is foreseen that the processor and the memory might be in different physical pieces of equipment or even in geographically distinct locations.

As used herein, the terms “media,” “medium” or “computer-readable media” include, but is not limited to, a diskette, a tape, a compact disc, an integrated circuit, a cartridge, a remote transmission via a communications circuit, or any other similar medium useable by computers. For example, to distribute computer system software, the supplier might provide a diskette or might transmit the instructions for performing predetermined operations in some form via satellite transmission, via a direct telephone link, or via the Internet.

Although computer system software might be “written on” a diskette, “stored in” an integrated circuit, or “carried over” a communications circuit, it will be appreciated that, for the purposes of this discussion, the computer usable medium will be referred to as “bearing” the instructions for performing predetermined operations. Thus, the term “bearing” is intended to encompass the above and all equivalent ways in which instructions for performing predetermined operations are associated with a computer usable medium.

Therefore, for the sake of simplicity, the term “program product” is hereafter used to refer to a computer-readable medium, as defined above, which bears instructions for performing predetermined operations in any form.

A detailed description of the aspects of the present invention will now be given referring to the accompanying drawings.

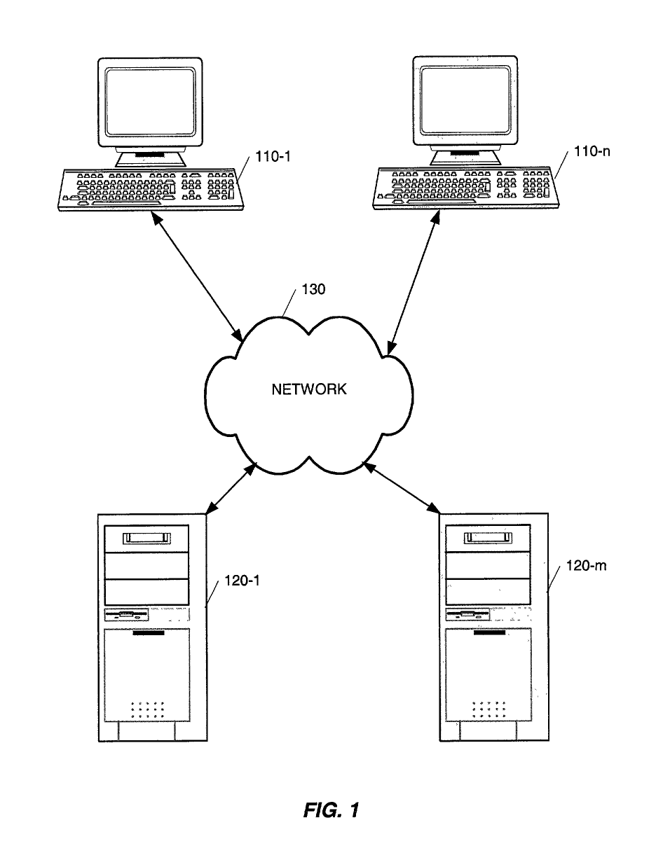

Referring to FIG. 1, a conventional architecture of a client-server environment 100 is illustrated. A plurality of clients 110-1 and 110-n (n is the total number of clients connected to the network) are connected to the network 130. In addition, a plurality of servers 120 and 120-m (m is the total number of servers connected to the network) are connected to the network 130 as well. The network 130, which may be composed from several sub-networks, enables the clients 110 and servers 120 to communicate with each other. For example, the client 110-1 sends a request to a server 120-1 over the network 130. The server 120-1 may receive multiple requests from multiple clients, and typically processes them in the order of receipt, or in other cases, according to a predefined prioritization policy. Requests queued in the server 120-1 wait their turn to be processed by the server 120-1. Once processed by the server 120-1, the response to the request is sent to the client of the server 120-1.

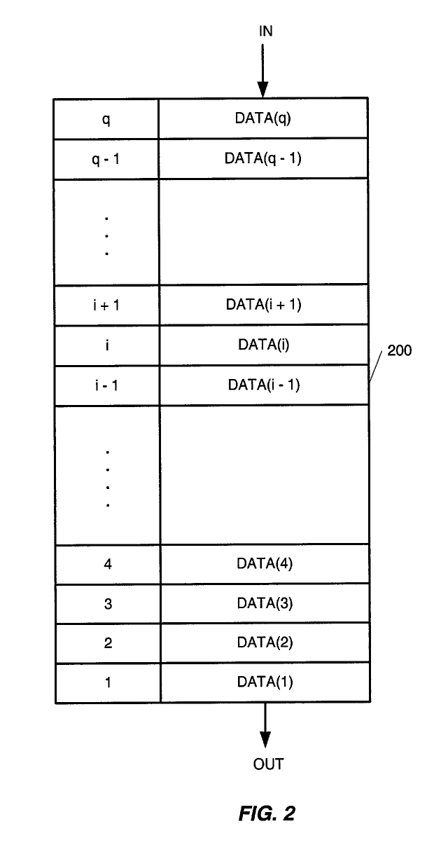

Referring to FIG. 2, a typical queue 200 handled by the server 120 is shown. A queue may have a depth of “q” locations, wherein each location is capable of storing one client request prior to its scheduled processing by the server 120. New client requests are placed at the first available slot in queue 200. This means that if slots “1” through “3” are taken by previous requests, a new client request will be placed in slot “4”. Similarly, if the queue 200 is filled up to and including slot “i-1”, then the next-to-be filled up slot is slot “i”. Client requests are always taken for processing from the first slot in the queue 200, i.e., slot “1”. Slot “1” may be a virtual location in as far as that its location is determined through a pointer that points to the location in the queue currently being location “1”, e.g., a cyclical queue. When queue 200 is full, i.e., slot “q” is taken, the server 120 will refuse to receive new requests from clients.

In order to maintain a desired level of service, a target latency (TL) from receipt of a client request by the server 120 until a response is sent back to the client 110 is defined. In addition, an average processing time (APT) is calculated, which is the average time it takes the server 120 to handle a single client request. The integer value resulting from the division of the target latency by the average processing time is referred to herein as the request threshold (RT) value. In accordance with the present invention, prior to handling the first client request in queue 200, server 120 performs a check to validate the number of client requests currently placed within the queue 200. If the number of client requests exceeds the request threshold value, then one or more of the client requests in the queue 200 are removed. Specifically, the client requests at the beginning of the queue 200, i.e., those closest to be processed by the server 120, are to be removed. Removal of the client requests at the beginning of the queue enables the successful processing of newer client requests that would otherwise time out as a result of the longer latency resulting from the overload of client requests directed to the server 200. It is likely that client requests that are just ready to be processed have already timed out, i.e., their corresponding client 110 has timed out.

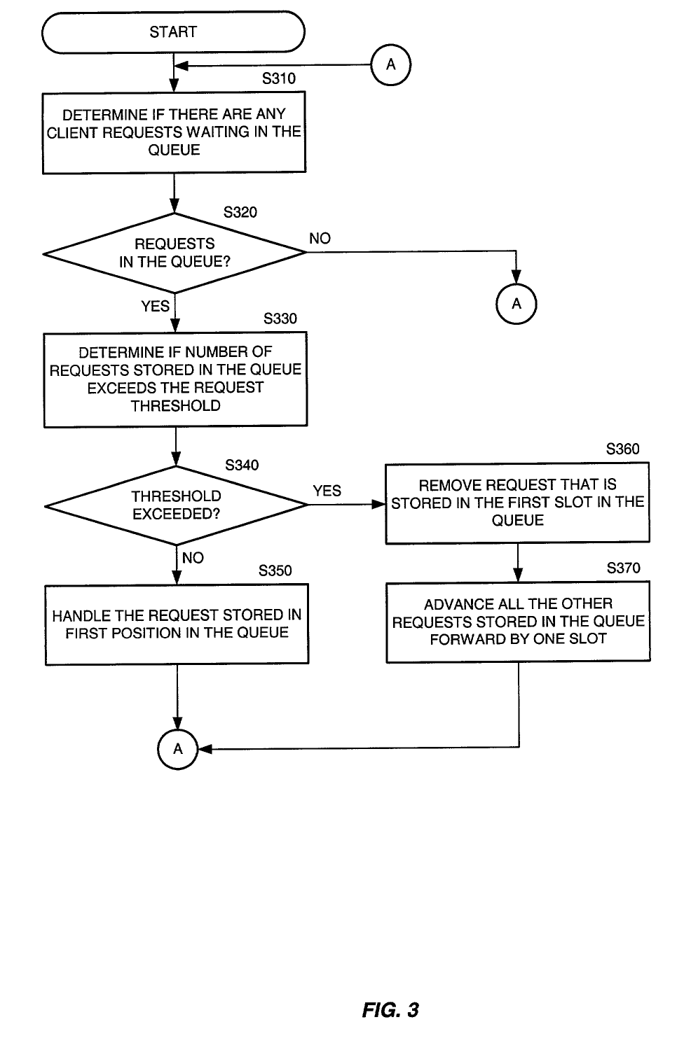

Referring to FIG. 3, an exemplary embodiment of a method for pulling a client request from queue 200 by server 120 is illustrated. At S310, a determination is made whether there are client requests in the queue. If there are no client requests to be processed, then the server loops to S310 through S320 until such time that there is a client request to be processed. If there are client requests in the queue, then, at S330, the server makes a determination if the number of client requests in queue 200 exceeds the request threshold value. If the number of client requests is equal or less than the request threshold value (S340), then, at S350, the server 120 handles the client request in the first slot of the queue 200. The server continues at S310 and repeats the process. The server will terminate the process if there is a program exception (not described); otherwise, the server will constantly execute the method.

If the number of client requests is greater than the request threshold value (S340), then, at S360, the first client request in the queue 200 is removed, i.e., the client request that would otherwise be the next client request to be processed by the server 120. At S370, the entire queue 200 is advanced by one step, i.e., the client request that was second in line to be processed becomes the first client request, the third client request becomes the second client request, and so forth. Execution continues with S310 where the process is repeated. However, it is also possible to continue the process at S330. A skilled artisan could easily use a threshold value other than the request threshold value. For example, any value between the request threshold value and the size of the queue 200 (i.e., total number of slots) may be used. In this case, the process of discarding the first client requests to the server 120 occurs only when that threshold is crossed. This value may further be defined based upon results of experiments relative to the characteristics of the network 100 and which provide the optimal results.

In an alternative embodiment, instead of looping until a client request is found in the queue 200 (S310/S320), the server terminates the process if no client requests are found in the queue 200. The server 120 periodically reinitiates the review of the contents of the queue 200. If a client request (or client requests) is found in the queue 200 (S310/S320), the processing of the client requests proceeds as described above.

Another exemplary embodiment of the present invention provides a computer software product for handling overload of client requests in a client-server environment, wherein the server comprises a request queue and a request manager. The computer software product comprises software instructions for enabling the server, the request queue and the request manager to perform predetermined operations, and a computer readable medium bearing the software instructions. The predetermined operations comprise the method for handling client requests that is described in the preceding paragraphs and illustrated in FIG. 3. Specifically, the predetermined operations determine if there are client requests in the queue and, if that determination is not true, wait until a client request is present. Alternatively, the predetermined operations could terminate the process at this point, and reinitiate it at a later point in time. Next, the predetermined operations determine that the number of client requests in the queue exceeds the request threshold value. If that determination is true, the predetermined operations repeatedly remove the client request in the first slot of the queue and advancing the remaining client requests in the queue by one position until the number of client requests is less than or equal to the request threshold value. When the number of client requests in the queue is less than or equal to the request threshold value, the predetermined operations process the client request that is now stored in the first slot of the queue.

Another exemplary embodiment of the present invention provides a computer system adapted for handling overload of client requests in a client-server environment, in accordance with the method described in the preceding paragraphs and illustrated in FIG. 3. In this embodiment, the computer system comprises at least one client and at least one server, and the client and the server are coupled to each other. Naturally, the computer system can comprise more than one server and more than one client, and the client and servers can be geographically distributed and interconnected using various known hardware and protocols. In the present invention, the computer system further comprises a memory having software instructions adapted to enable the computer system to perform operations. The software instructions determine if there are requests in the queue and, if that determination is not true, wait until a request is present. The software instructions executed by the computer system determine if the number of requests in the queue exceeds the request threshold value. If that determination is true, the software instructions command the computer system to remove the request in the first slot of the queue and advance the remaining requests in the queue by one position. This process is repeated until the number of client requests is less than or equal to the request threshold value. Finally, once the number of client requests in the queue are less than or equal to the request threshold value, the software instructions cause the computer system to process the client request stored in the first slot of the queue.

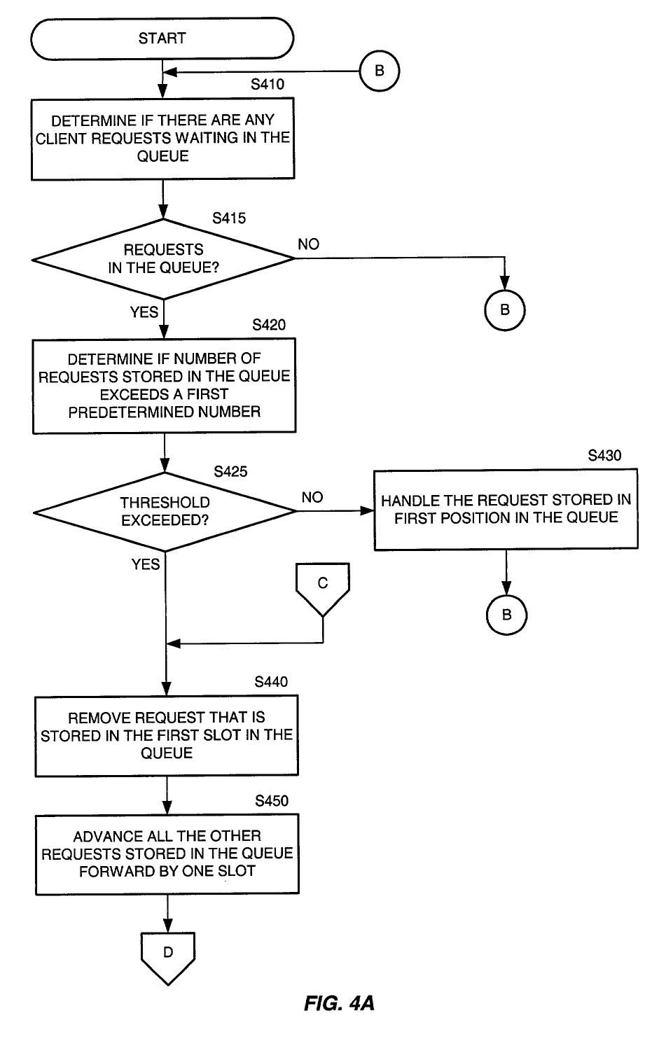

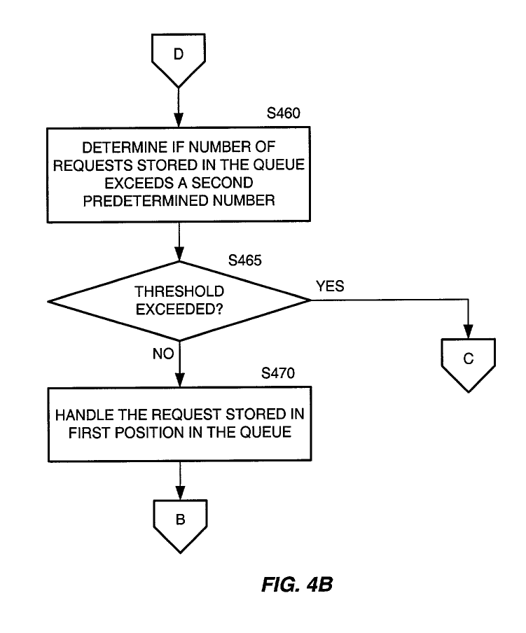

Referring to FIGS. 4A-4B, another exemplary embodiment of a method for pulling a client request from queue 200 by server 120 is illustrated. At S410, a determination is made whether there are client requests in the queue. If there are no requests to be processed, then the server loops to S410 through S415 until such time that there is a client request to be processed. If there are requests in the queue, then, at S420, the server makes a determination if the number of client requests in queue 200 exceeds a first predetermined number. The first predetermined number is a number that is larger than the result of the average response time of the server to a client request divided by an average time used by the server to process the client request, i.e., a number larger than the request threshold described above. If the number of client requests is equal or less than the first predetermined number (S425), then, at S430, the server 120 handles the client request in the first slot of the queue 200. The server continues at S410 and repeats the process. The server will terminate the process if there is a program exception (not described); otherwise, the server will constantly execute the method.

If the number of client requests is greater than the first predetermined number (S425), then, at S440, the client request in the first slot of the queue 200 is removed, i.e., the client request that would otherwise be the next request to be processed by the server 120. At S450, the entire queue 200 is advanced by one step, i.e., the client request that was second in line to be processed becomes the first client request, the third client request becomes the second client request, and so forth. At S460, the server makes a determination if the number of client requests stored in the queue exceeds a second predetermined number. The second predetermined number is the result of the average response time of the server to a client request divided by the average time used by the server to process the client request. If the number of client requests exceeds the second predetermined number (S465), then execution continues at S440. If the number of client requests is equal to or less than the second predetermined number, the client request in the first slot of the queue is handled at S470, and execution continues at S410.

In an alternative embodiment, instead of looping until a client request is found in the queue 200 (S410/S415), the server terminates the process if no client requests are found in the queue 200. The server 120 periodically reinitiates the review of the contents of the queue 200. If a client request (or client requests) is found in the queue 200 (S410/S415), the processing of the client requests proceeds as described above.

Another exemplary embodiment of the present invention provides a computer software product for handling overload of requests in a client-server environment, the server having a request queue and a request manager, in accordance with the method described in the preceding paragraphs and illustrated in FIGS. 4A-4B. The computer software product comprises software instructions for enabling the server, the request queue and the request manager to perform predetermined operations, and a computer readable medium bearing the software instructions. The predetermined operations comprise the method for handling client requests that is described in the preceding paragraphs and as illustrated in FIGS. 4A-4B. Specifically, the predetermined operations determine if there are client requests in the queue. Based upon that determination, the predetermined operations will wait until a client request is present. Alternatively, the predetermined operations could terminate the process and reinitiate at a later point in time to determine if there are client requests present in the queue. Next, if the predetermined operations determine that the number of client requests in the queue exceeds a first predetermined number, then the predetermined operations remove the client request in the first slot of the queue and advancing the remaining client requests in the queue by one position. The first predetermined number is a number that is larger than the result of the average response time of the server to a client request divided by an average time used by the server to process the client request, i.e., a number larger than the request threshold value described above. The predetermined operations repeat the removal of client requests from the queue until the number of client requests in the queue is less than a second predetermined number. The second predetermined number, which is the result of the average response time of the server to a client request divided by the average time used by the server to process the client request. The second predetermined number is smaller than the first predetermined number. Once the number of client requests pending in the queue is less than the second predetermined number, the predetermined operations process the request that is now stored in the first slot of the queue.

Another exemplary embodiment of the present invention provides a computer system adapted for handling overload of client requests in a client-server environment, in accordance with the method described in the preceding paragraphs and illustrated in FIGS. 4A-4B. The computer system comprises at least one client and at least one server, wherein the client and the server are coupled to each other. It is understood, however, that the computer system can comprise several clients and servers spread around geographically and linked together by various network hardware and protocols. The computer system further comprises a memory having software instructions adapted to enable the computer system to perform operations. First, the software instructions determine if there are client requests in the queue. Based upon that determination, the software instructions will command the computer system to wait until a client request is present in the queue. Alternatively, the software instructions could terminate the process and reinitiate the process at a later time to check if there are client requests entered in the queue. Next, the software instructions determine if the number of client requests in the queue exceeds a first predetermined number. The first predetermined number is a number that is larger than the result of the average response time of the server to a client request divided by an average time used by the server to process the client request, i.e., a number larger than the request threshold value described earlier. Based on that determination, the software instructions command the computer system to remove the client request in the first slot of the queue and advance the remaining client requests in the queue by one position. The software instructions repeat the removal of client requests from the queue until the number of client requests in the queue is less than a second predetermined number, which is the result of the average response time of the server to a client request divided by the average time used by the server to process the client request. The second predetermined number is smaller than the first predetermined number. Finally, once the number of client requests in the queue is less than or equal to the second predetermined number, the software instructions process the client request that is now stored in the first slot of the queue.

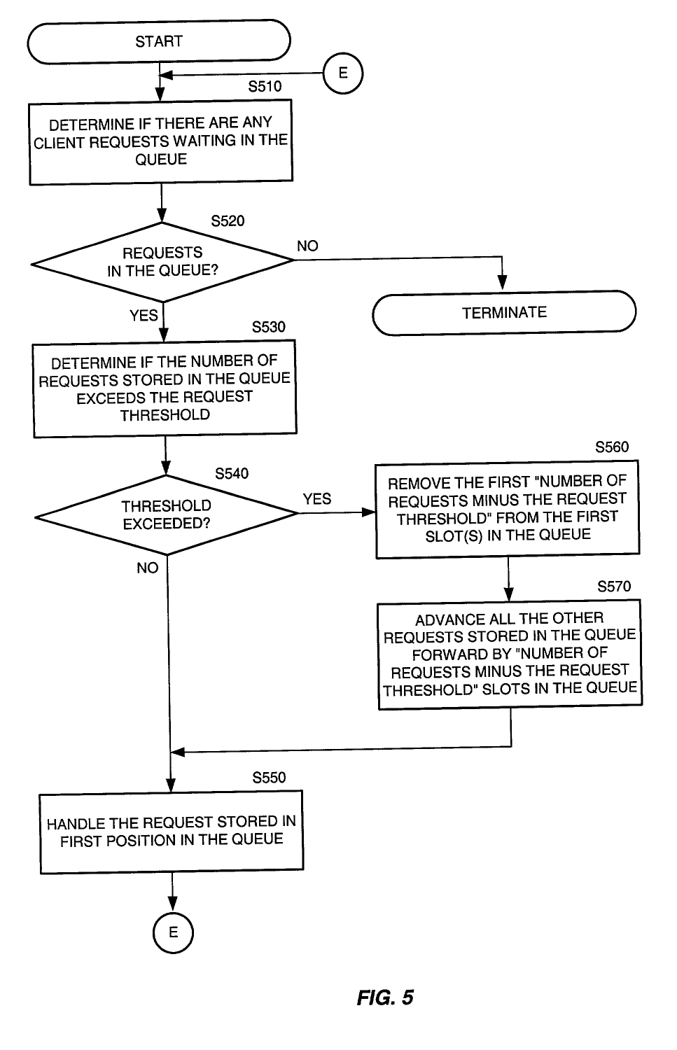

Referring to FIG. 5, another exemplary embodiment of a method for pulling a client request from the queue 200 by the server 120 is illustrated. At S510, a determination is made whether there are client requests in the queue. If it is determined in S520 that there are no client requests to be processed, the method terminates. In an alternative embodiment, if there are no client requests to be processed, then the process flow returns to S510 through S520 until such time that there is a client request to be processed. If there are client requests in the queue, then, at S530, a determination is made if the number of client requests in queue 200 exceeds the request threshold value. If the number of client requests is equal or less than the request threshold value (S540), then, at S550, the server 120 handles the client request in the first slot of the queue 200. The method then continues with S510.

If the number of client requests is greater than request threshold value, then, at S560, one or more client requests are removed from the beginning of queue 200, i.e., the client requests that the server 120 will process next. The number of client requests to be removed from the queue 200 is determined as the difference between the actual number of client requests and request threshold value. At S570, the entire queue 200 is forwarded by one or more positions. The number of positions to be forwarded is determined as the difference between the actual number of client requests and the request threshold value. Execution continues at S550 as explained above. A person skilled in the art could easily use as a threshold value a value other then the request threshold value. For example, any value between the request threshold value and the size of queue 200 (i.e., number of slots) may be used. In this case, the first group of client requests to the server 120 is discarded only when that threshold is crossed. This value may further be defined based upon results of experiments relative to the characteristics of the network 100 and which provide the optimal results.

In the embodiment where the process is terminated if no requests are found in the queue 200, the server 120 periodically reinitiates the review of the contents of the queue 200. This is done by reinitiating the method described herein.

Another exemplary embodiment of the present invention provides a computer software product for handling overload of client requests in a client-server environment, the server having a request queue and a request manager, in accordance with the method described in the preceding paragraphs and as illustrated in FIG. 5. The computer software product comprises software instructions for enabling the server, the request queue and the request manager to perform predetermined operations, and a computer readable medium bearing the software instructions. The predetermined operations comprise the method for handling client requests that is described in the preceding paragraphs and as illustrated in FIG. 5. Specifically, the predetermined operations determine if there are client requests in the queue and, based upon that determination, command the server to wait until a client request is present in the queue. If the predetermined operations determine that the number of client requests in the queue exceeds the request threshold value, the predetermined operations remove from the queue a number of client requests that is equal to the difference between the actual number of client requests in the queue and the request threshold value. The predetermined operations then advance the remaining client requests in the queue by a number of positions equal to the difference between the actual number of client requests in the queue and the request threshold value. After the remaining client requests have been advanced in the queue, the predetermined operations process the client request that is now stored in the first slot of the queue.

Another exemplary embodiment of the present invention provides a computer system adapted for handling overload of requests in a client-server environment, in accordance with the method described in the preceding paragraphs and as illustrated in FIG. 5. The computer system comprises at least one client and at least one server, and the client and the server are coupled to each other. It is understood, however, that the computer system can comprise several clients and servers spread around geographically and linked together by various network hardware and protocols. The computer system further comprises a memory having software instructions adapted to enable the computer system perform operations. First, the software instructions command the computer system to determine if there are client requests in the queue. The computer system will process the queue or wait for a client request to be entered in the queue, based upon that determination. Next, the software instructions determine if the number of client requests in the queue exceeds the request threshold value. If that determination is true, the software instructions command the computer system to remove from the queue a number of client requests equal to the difference between the actual number of client requests in the queue and the request threshold value. After the requisite number of client requests have been removed from the queue, the software instructions command the computer system to advance the remaining client requests in the queue by a number of positions equal to the difference between the actual number of requests in the queue and the request threshold value. After the remaining client requests in the queue have been advanced, the software instructions process the client request now stored in the first slot of the queue.

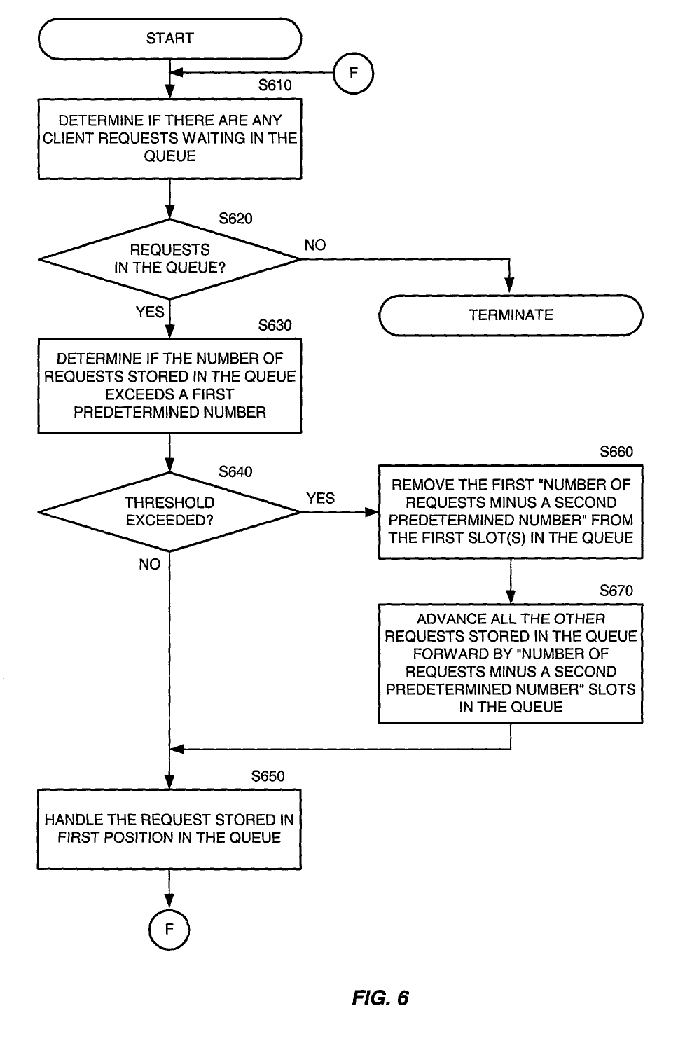

Referring to FIG. 6, another exemplary embodiment of a method for pulling a client request from the queue 200 by the server 120 is illustrated. At S610, a determination is made whether there are client requests in the queue. If it is determined at S620 that there are no client requests to be processed, the method terminates. In an alternative embodiment, if there are no client requests to be processed, then the process flow returns to S610 through S620 until such time that there is a client request to be processed. If there are client requests in the queue, then, at S630, a determination is made if the number of client requests in queue 200 exceeds a first predetermined number. The first predetermined number is a number that is larger than the result of the average response time of the server to a client request divided by an average time used by the server to process the client request, i.e., a number larger than the request threshold value described earlier. If the number of client requests is equal or less than the first predetermined number (S640), then, at S650, the server 120 handles the client request in the first slot of queue 200. The method then continues with S610.

If the number of client requests is greater than the first predetermined number, then, at S660, one or more client requests are removed from the beginning of queue 200, i.e., the client requests that the server 120 will process next. The number of client requests to be removed from the queue 200 is determined as the difference between the actual number of client requests and a second predetermined number, which is the result of the average response time of the server to a client request divided by the average time used by the server to process the client request. The second predetermined number is smaller than the first predetermined number. At S670, the entire queue 200 is forwarded by one or more positions. The number of positions to be forwarded is determined as the difference between the actual number of client requests and the second predetermined number. Execution continues at S650 as explained above.

In an embodiment where the process is terminated if no requests are found in the queue 200, the server 120 periodically reinitiates the review of the contents of the queue 200. This is done by reinitiating the method described herein.

Another exemplary embodiment of the present invention provides a computer software product for handling overload of client requests in a client-server environment, the server having a request queue and a request manager, in accordance with the method described in the preceding paragraphs and as illustrated in FOG. 6. The computer software product comprises software instructions for enabling the server, the request queue and the request manager to perform predetermined operations, and a computer readable medium bearing the software instructions. The predetermined operations implement the method described in the preceding paragraphs and as illustrated in FIG. 5. Specifically, the predetermined operations comprise determining if there are client requests in the queue. If that determination is not true, the predetermined operations wait until a client request is present in the queue. Alternatively, if no client requests are in the queue, the predetermined operations could terminate the process and reinitiate the process at a later time to determine if client requests have been entered in the queue. Next, the predetermined operations determine if the number of client requests in the queue exceeds a first predetermined number. The first predetermined number is a number that is larger than the result of the average response time of the server to a client request divided by an average time used by the server to process the client request, i.e., a number larger than the request threshold value described earlier. If that determination is true, the predetermined operations remove from the queue a number of client requests equal to the difference between the actual number of requests in the queue and a second predetermined number. The second predetermined number is the result of the average response time of the server to a client request divided by the average time used by the server to process the client request. The second predetermined number is smaller than the first predetermined number. After the requisite number of client requests have been removed from the queue, the predetermined operations advance the remaining client requests the queue by a number of positions equal to the difference between the actual number of client requests in the queue and the second predetermined number. Finally, after the advancement of the remaining client requests in the queue, the predetermined operations process the request that is now stored in the first slot of the queue.

Another exemplary embodiment of the present invention provides a computer system adapted for handling overload of client requests in a client-server environment, in accordance with the method described in the preceding paragraphs and as illustrated in FIG. 6. The computer system comprises at least one client and at least one server, wherein the client and the server are coupled to each other. It is understood, however, that the computer system can comprise several clients and servers spread around geographically and linked together by various network hardware and protocols. The computer system further comprises a memory comprising software instructions adapted to enable the computer system to perform operations. The software instructions determine if there are client requests in the queue and, if that determination is not true, wait until a client request is present. The software instructions determine if the number of client requests in the queue exceeds the first predetermined number. The first predetermined number is a number that is larger than the result of the average response time of the server to a client request divided by an average time used by the server to process the client request, i.e., a number larger than the request threshold value described earlier. If that determination is true, the software instructions remove from the queue a number of client requests equal to the difference between the actual number of client requests in the queue and a second predetermined number. The second predetermined number is the result of the average response time of the server to a client request divided by the average time used by the server to process the client request. The second predetermined number is smaller than the first predetermined number. The software instructions advance the remaining client requests the queue by a number of positions equal to the difference between the actual number of client requests in the queue and the second predetermined number. Finally, the software instructions process the client request that is now stored in the first slot of the queue.

The foregoing description of the aspects of the present invention has been presented for purposes of illustration and description. It is not intended to be exhaustive or to limit the present invention to the precise form disclosed, and modifications and variations are possible in light of the above teachings or may be acquired from practice of the present invention. The principles of the present invention and its practical application were described in order to explain the to enable one skilled in the art to utilize the present invention in various embodiments and with various modifications as are suited to the particular use contemplated.

Thus, while only certain aspects of the present invention have been specifically described herein, it will be apparent that numerous modifications may be made thereto without departing from the spirit and scope of the present invention. Further, acronyms are used merely to enhance the readability of the specification and claims. It should be noted that these acronyms are not intended to lessen the generality of the terns used and they should not be construed to restrict the scope of the claims to the embodiments described therein.

What is claimed is:

1. A server capable of receiving requests from at least one client, said server comprising:
a queue for handling requests received from said at least one client;
a queue manager that removes at least the next-to-be handled request from said queue when the number of requests in said queue exceeds a request threshold value.

2. The server of claim 1, wherein said server is connected to said client through a network.

3. The server of claim 2, wherein said network is a local area network (LAN), a wide area network (WAN), an Infiniband network or asynchronous transfer mode (ATM) network.

4. The server of claim 1, wherein said queue is a first-in first-out queue.

5. The server of claim 1, wherein said queue is a virtual queue.

6. The server of claim 1, wherein said request threshold value is the result of an average response time of said server to a client request divided by an average time used by said server to process said client request.

7. The server of claim 6, wherein said response time is an elapsed time from the receipt of said client request until the time said server completes handling of said client request.

8. The server of claim 1, wherein said request threshold value is a first predetermined number that is larger than the result of an average response time of said server to a client request divided by an average time used by said server to process said client request.

9. The server of claim 8, wherein said response time is an elapsed time from the receipt of said client request until the time said server completes handling of said client request.

10. The server of claim 1, wherein, prior to processing said queue, said queue manager:
determines if there are requests in said queue and, if that determination is not true, waits until a request is present;
determines if the number of requests in said queue exceeds said request threshold value, and, if that determination is true, repeatedly removes the request in the first slot of said queue and advances the remaining requests in said queue by one position until the number of requests is less than or equal to said request threshold value; and
processes the request stored in the first slot of said queue.

11. The server of claim 10, wherein said queue manager terminates if no requests are found in said queue.

12. The server of claim 1, wherein, prior to processing said queue, said queue manager:
determines if there are requests in said queue and, if that determination is not true, waits until a request is present;
determines if the number of requests in said queue exceeds said request threshold value, and, if that determination is true, removes from said queue a number of requests equal to the difference between the actual number of requests in said queue and said request threshold value, and advances the remaining requests said queue by a number of positions equal to the difference between the actual number of requests in said queue and said request threshold value; and
processes the request stored in the first slot of said queue.

13. The server of claim 12, wherein said queue manager terminates if no requests are found in said queue.

14. The server of claim 8, wherein, prior to processing said queue, said queue manager:
determines if there are requests in said queue and, if that determination is not true, waits until a request is present;
determines if the number of requests in said queue exceeds said first predetermined number, and, if that determination is true, repeatedly removes the request in the first slot in said queue and advances the remaining requests in said queue by one position until the number of requests in said queue is less than a second predetermined number, which is smaller than said first predetermined number of requests; and
processes the request stored in the first slot of said queue.

15. The server of claim 14, said queue manager terminates if no requests are found in said queue.

16. The server of claim 14, wherein said second predetermined number is the result of an average response time of said server to a client request divided by an average time used by said server to process said client request.

17. The server of claim 8, wherein, prior to processing said queue, said queue manager:
determines if there are requests in said queue and, if that determination is not true, waits until a request is present;
determines if the number of requests in said queue exceeds said first predetermined number, and, if that determination is true, removes from said queue a number of requests equal to the difference between the actual number of requests in said queue and a second predetermined number which is smaller than said first predetermined number, and advances the remaining requests said queue by a number of positions equal to the difference between the actual number of requests in said queue and said second predetermined number; and
processes the request stored in the first slot of said queue.

18. The server of claim 17, said queue manager terminates if no requests are found in said queue.

19. The server of claim 17, wherein said second predetermined number is the result of an average response time of said server to a client request divided by an average time used by said server to process said client request.

20. A method for handling overload of requests in a client-server environment, said server having a request queue and a request manager, wherein:
said request manager determines if there are requests in said queue and, if that determination is not true, waits until a request is present;
if said request manager determines that the number of requests in said queue exceeds said request threshold value, said request manager repeatedly removes the request in the first slot of said queue and advances the remaining requests in said queue by one position until the number of requests is less than or equal to said request threshold value; and
said request manager processes the request stored in the first slot of said queue.

21. The method of claim 20, wherein said request manager terminates if no requests are found in said queue.

22. The method of claim 20, wherein said request threshold value is the result of an average response time of said server to a client request divided by an average time used by said server to process said client request.

23. The method of claim 20, wherein said requests are sent from said client to said server over a network.

24. The method of claim 23, wherein said network a local area network (LAN), a wide area network (WAN), an Infiniband network or an asynchronous transfer mode (ATM) network.

25. The method of claim 20, wherein said queue is a first-in first-out queue.

26. The method of claim 20, wherein said queue is a virtual queue.

27. A method for handling overload of requests in a client-server environment, said server having a request queue and a request manager, wherein:
said request manager determines if there are requests in said queue and, if that determination is not true, waits until a request is present;
if said request manager determines that the number of requests in said queue exceeds said request threshold value, said request manager removes from said queue a number of requests equal to the difference between the actual number of requests in said queue and said request threshold value, and advances the remaining requests said queue by a number of positions equal to the difference between the actual number of requests in said queue and said request threshold value; and
said request manager processes the request stored in the first slot of said queue.

28. The method of claim 27, said request manager terminates if no requests are found in said queue.

29. The method of claim 27, wherein said request threshold value is the result of an average response time of said server to a client request divided by an average time used by said server to process said client request.

30. The method of claim 27, wherein said requests are sent from said client to said server over a network.

31. The method of claim 30, wherein said network is a local area network (LAN), a wide area network (WAN), an Infiniband network or an asynchronous transfer mode (ATM) network.

32. The method of claim 27, wherein said queue is a first-in first-out queue.

33. The method of claim 27, wherein said queue is a virtual queue.

34. A method for handling overload of requests in a client-server environment, said server having a request queue and a request manager, wherein:
said request manager determines if there are requests in said queue and, if that determination is not true, waits until a request is present;
if said request manager determines that the number of requests in said queue exceeds said first predetermined number, said request manager repeatedly removes the request in the first slot of said queue and advances the remaining requests in said queue by one position until the number of requests in said queue is less than a second predetermined number, which is smaller than said first predetermined number of requests; and
said request manager processes the request stored in the first slot of said queue.

35. The method of claim 34, said request manager terminates if no requests are found in said queue.

36. The method of claim 34, wherein said second predetermined number is the result of an average response time of said server to a client request divided by an average time used by said server to process said client request.

37. The method of claim 34, wherein said requests are sent from said client to said server over a network.

38. The method of claim 37, wherein said network is a local area network (LAN), a wide area network (WAN), an Infiniband network or an asynchronous transfer mode (ATM) network.

39. The method of claim 34, wherein said queue is a first-in first-out queue.

40. The method of claim 34, wherein said queue is a virtual queue.

41. A method for handling overload of requests in a client-server environment, said server having a request queue and a request manager, wherein:
said request manager determines if there are requests in said queue and, if that determination is not true, waits until a request is present;
said request manager determines if the number of requests in said queue exceeds said first predetermined number, and, if that determination is true, removes from said queue a number of requests equal to the difference between the actual number of requests in said queue and a second predetermined number which is smaller than said first predetermined number, and advances the remaining requests said queue by a number of positions equal to the difference between the actual number of requests in said queue and said second predetermined number; and
said request manager processes the request stored in the first slot of said queue.

42. The method of claim 41, said request manager terminates if no requests are found in said queue.

43. The method of claim 41, wherein said second predetermined number is the result of an average response time of said server to a client request divided by an average time used said server to process said client request.

44. The method of claim 41, wherein said requests are sent from said client to said server over a network.

45. The method of claim 44, wherein said network is a local area network (LAN), a wide area network (WAN), an Infiniband network or an asynchronous transfer mode (ATM) network.

46. The method of claim 41, wherein said queue is a first-in first-out queue.

47. The method of claim 41, wherein said queue is a virtual queue.

48. A computer software product for handling overload of requests in a client-server environment, said server having a request queue and a request manager, said computer software product comprises:
software instructions for enabling said server, said request queue and said request manager to perform predetermined operations, and a computer readable medium bearing the software instructions, said predetermined operations comprise:
determining if there are requests in said queue and, if that determination is not true, waiting until a request is present;
if said predetermined operations determine that the number of requests in said queue exceeds said request threshold value, said predetermined operations repeatedly removing the request in the first slot of said queue and advancing the remaining requests in said queue by one position until the number of requests is less than or equal to said request threshold value; and
processing the request stored in the first slot of said queue.

49. The computer software product of claim 48, said request manager terminates if no requests are found in said queue.

50. The computer software product of claim 48, wherein said request threshold value is the result of an average response time of said server to a client request divided by an average time used by said server to process said client request.

51. The computer software product of claim 48, wherein said requests are sent from said client to said server over a network.

52. The computer software product of claim 5 1, wherein said network is a local area network (LAN), a wide area network (WAN), an Infiniband network or an asynchronous transfer mode (ATM) network.

53. The computer software product of claim 48, wherein said queue is a first-in first-out queue.

54. The computer software product of claim 48, wherein said queue is a virtual queue.

55. A computer software product for handling overload of requests in a client-server environment, said server having a request queue and a request manager, said computer software product comprises:
software instructions for enabling said server, said request queue and said request manager to perform predetermined operations, and a computer readable medium bearing the software instructions, said predetermined operations comprise:
determining if there are requests in said queue and, based upon that determination, waiting until a request is present;
if said predetermined operations determine that the number of requests in said queue exceeds said request threshold value, said predetermined operations removing from said queue a number of requests equal to the difference between the actual number of requests in said queue and said request threshold value, and advancing the remaining requests said queue by a number of positions equal to the difference between the actual number of requests in said queue and said request threshold value; and
processing the request stored in the first slot of said queue.

56. The computer software product of claim 55, said request manager terminates if no requests are found in said queue.

57. The computer software product of claim 55, wherein said request threshold value is the result of an average response time of said server to a client request divided by an average time used by said server to process said client request.

58. The computer software product of claim 55, wherein said requests are sent from said client to said server over a network.

59. The computer software product of claim 58, wherein said network is a local area network (LAN), a wide area network (WAN), an Infiniband network or an asynchronous transfer mode (ATM) network.

60. The computer software product of claim 55, wherein said queue is a first-in first-out queue.

61. The computer software product of claim 55, wherein said queue is a virtual queue.

62. A computer software product for handling overload of requests in a client-server environment, said server having a request queue and a request manager, said computer software product comprises:
software instructions for enabling said server, said request queue and said request manager to perform predetermined operations, and a computer readable medium bearing the software instructions, said predetermined operations comprise:
determining if there are requests in said queue and, based upon that determination, waiting until a request is present;
if said predetermined operations determine that the number of requests in said queue exceeds said first predetermined number, said predetermined operations repeatedly removing the request in the first slot of said queue and advancing the remaining requests in said queue by one position until the number of requests in said queue is less than a second predetermined number, which is smaller than said first predetermined number of requests; and
processing the request stored in the first slot of said queue.

63. The computer software product of claim 62, said request manager terminates if no requests are found in said queue.

64. The computer software product of claim 62, wherein said second predetermined number is the result of an average response time of said server to a client request divided by an average time used by said server to process said client request.

65. The computer software product of claim 62, wherein said requests are sent from said client to said server over a network.

66. The computer software product of claim 65, wherein said network is a local area network (LAN), a wide area network (WAN), an Infiniband network or an asynchronous transfer mode (ATM) network.

67. The computer software product of claim 62, wherein said queue is a first-in first-out queue.

68. The computer software product of claim 62, wherein said queue is a virtual queue.

69. A computer software product for handling overload of requests in a client-server environment, said server having a request queue and a request manager, said computer software product comprises:
software instructions for enabling said server, said request queue and said request manager to perform predetermined operations, and a computer readable medium bearing the software instructions, said predetermined operations comprise:
determining if there are requests in said queue and, if that determination is not true, waits until a request is present;
determining if the number of requests in said queue exceeds said first predetermined number, and, if that determination is true, removing from said queue a number of requests equal to the difference between the actual number of requests in said queue and a second predetermined number which is smaller than said first predetermined number, and advancing the remaining requests said queue by a number of positions equal to the difference between the actual number of requests in said queue and said second predetermined number; and
processing the request stored in the first slot of said queue.

70. The computer software product of claim 69, said request manager terminates if no requests are found in said queue.

71. The computer software product of claim 69, wherein said second predetermined number is the result of an average response time of said server to a client request divided by an average time used by said server to process said client request.

72. The computer software product of claim 69, wherein said requests are sent from said client to said server over a network.

73. The computer software product of claim 72, wherein said network is a local area network (LAN), a wide area network (WAN), an Infiniband network or an asynchronous transfer mode (ATM) network.

74. The computer software product of claim 69, wherein said queue is a first-in first-out queue.

75. The computer software product of claim 69, wherein said queue is a virtual queue.

76. A computer system adapted for handling overload of requests in a client-server environment, the computer system comprising:
at least one client and at least one server, wherein said at least one client and said at least one server are coupled to each other;
a memory comprising software instructions adapted to enable the computer system to:
determine if there are requests in said queue and, if that determination is not true, wait until a request is present;
determine if the number of requests in said queue exceeds said request threshold value, and, if that determination is true, repeatedly remove the request in the first slot of said queue and advance the remaining requests in said queue by one position until the number of requests is less than or equal to said request threshold value; and
process the request stored in the first slot of said queue.

77. The computer system of claim 76, said software instructions are further adapted to terminate if no requests are found in said queue.

78. The computer system of claim 76, wherein said request threshold value is the result of an average response time of said server to a client request divided by an average time used by said server to process said client request.

79. The computer system of claim 76, wherein said requests are sent from said client to said server over a network.

80. The computer system of claim 79, wherein said network is a local area network (LAN), a wide area network (WAN), an Infiniband network or an asynchronous transfer mode (ATM) network.

81. The computer system of claim 76, wherein said queue is a first-in first-out queue.

82. The computer system of claim 76, wherein said queue is a virtual queue.

83. A computer system adapted for handling overload of requests in a client-server environment, the computer system comprising:
at least one client and at least one server, wherein said at least one client and said at least one server are coupled to each other;
a memory comprising software instructions adapted to enable the computer system to:
determine if there are requests in said queue and, based upon that determination, wait until a request is present;
determine if the number of requests in said queue exceeds said request threshold value, and, if that determination is true, remove from said queue a number of requests equal to the difference between the actual number of requests in said queue and said request threshold value, and advance the remaining requests said queue by a number of positions equal to the difference between the actual number of requests in said queue and said request threshold value; and
process the request stored in the first slot of said queue.

84. The computer system of claim 83, said software instructions are further adapted to terminate if no requests are found in said queue.

85. The computer system of claim 83, wherein said request threshold value is the result of an average response time of said server to a client request divided by an average time used by said server to process said client request.

86. The computer system of claim 83, wherein said requests are sent from said client to said server over a network.

87. The computer system of claim 86, wherein said network is a local area network (LAN), a wide area network (WAN), an Infiniband network or an asynchronous transfer mode (ATM) network.

88. The computer system of claim 83, wherein said queue is a first-in first-out queue.

89. The computer system of claim 83, wherein said queue is a virtual queue.

90. A computer system adapted for handling overload of requests in a client-server environment, the computer system comprising:
at least one client and at least one server, wherein said at least one client and said at least one server are coupled to each other;
a memory comprising software instructions adapted to enable the computer system to:
determine if there are requests in said queue and, based upon that determination, wait until a request is present;
determine if the number of requests in said queue exceeds said first predetermined number, and, based on that determination, repeatedly remove the request in the first slot of said queue and advance the remaining requests in said queue by one position until the number of requests in said queue is less than a second predetermined number, which is smaller than said first predetermined number of requests; and
process the request stored in the first slot of said queue.

91. The computer system of claim 90, said software instructions are further adapted to terminate if no requests are found in said queue.

92. The computer system of claim 90, wherein said second predetermined number is the result of an average response time of said server to a client request divided by an average time used by said server to process said client request.

93. The computer system of claim 90, wherein said requests are sent from said client to said server over a network.

94. The computer system of claim 93, wherein said network is a local area network (LAN), a wide area network (WAN), an Infiniband network or an asynchronous transfer mode (ATM) network.

95. The computer system of claim 90, wherein said queue is a first-in first-out queue.

96. The computer system of claim 90, wherein said queue is a virtual queue.

97. A computer system adapted for handling overload of requests in a client-server environment, the computer system comprising:
at least one client and at least one server, wherein said at least one client and said at least one server are coupled to each other;
a memory comprising software instructions adapted to enable the computer system to:
determine if there are requests in said queue and, if that determination is not true, waits until a request is present;
determine if the number of requests in said queue exceeds said first predetermined number, and, if that determination is true, remove from said queue a number of requests equal to the difference between the actual number of requests in said queue and a second predetermined number which is smaller than said first predetermined number, and advance the remaining requests said queue by a number of positions equal to the difference between the actual number of requests in said queue and said second predetermined number; and
process the request stored in the first slot of said queue.

98. The computer system of claim 97, said software instructions are further adapted to terminate if no requests are found in said queue.

99. The computer system of claim 97, wherein said second predetermined number is the result of an average response time of said server to a client request divided by an average time used by said server to process said client request.

100. The computer system of claim 97, wherein said requests are sent from said client to said server over a network.

101. The computer system of claim 100, wherein said network is a local area network (LAN), a wide area network (WAN), an Infiniband network or an asynchronous transfer mode (ATM) network.

102. The computer system of claim 97, wherein said queue is a first-in first-out queue.

103. The computer system of claim 97, wherein said queue is a virtual queue.
